(19) United States
(12) Patent Application Publication
(10) Pub. No.: US 2007/0002925 A1
(43) Pub. Date: Jan. 4, 2007

(54) External cavity laser diode system and method thereof

(75) Inventors: Mark Zediker, St. Charles, MO (US); Brian Faircloth, Ballwin, MO (US); John Haake, St. Charles, MO (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Nuvonyx, Inc., Bridgeton, MO (US)

(21) Appl. No.: 11/256,926

(22) Filed: Oct. 25, 2005

Related U.S. Application Data
(60) Provisional application No. 60/621,088, filed on Oct. 25, 2004.

(51) Int. Cl. H01S 3/13; H01S 3/08

(52) U.S. Cl. 372/98; 372/29.023

(57) ABSTRACT

A method (and system) of coherently combining a plurality of diodes in an external cavity laser diode system includes adjusting the phase of the plurality of diodes to correct phase errors, wherein the adjusting the phase includes intercavity phase adjustment. The laser diode external cavity system includes an adjuster for intercavity phase adjustment.

### CROSS REFERENCE TO RELATED APPLICATIONS

The present application is related to U.S. Provisional Patent Application No. 60/621,088 filed on Oct. 25, 2004, to Zediker et al., entitled “EXTERNAL CAVITY LASER DIODE SYSTEM” having client Docket No. NUV.008, which is incorporated, in its entirety, herein by reference.

### BACKGROUND OF THE INVENTION

1. Field of the Invention

The present invention generally relates to a method and apparatus for coherently combining the outputs of laser diode sources, and more particularly to a method and apparatus for coherently coupling the output of an array of diodes in an external cavity laser diode system.

2. Description of the Related Art

External cavities laser diode systems have been developed for coherently combining a plurality of laser diodes. However, most of the previous efforts resulted in only a few hundred milliwatts to Watts of power. This disclosure provides a means for scaling a high brightness laser diode system to much higher power levels.

Certain conventional devices have demonstrated successful locking of an array of vertical cavity surface emitters by injection locking. These devices adjusted the phase of each emitter by changing the bias on the device. The phase was adjusted using a phase conversion plate. The resulting beam, however, had a low fill factor and, as a consequence, the far-field profile was multi-lobed.

Several issues must be considered when scaling-up a laser diode system to a high power level. These issues include the high current that needs to be delivered to the surface emitter array, the heat load on the phase conversion plate used to improve the fill factor, and the long term stability of injection locking a source, which must start within the locking bandwidth of the master emitter. While the above-mentioned conventional device may demonstrate long term phase locked stability, the conventional device does not address what happens when the device is turned on and off again, or the temperature sensitivities of the device.

Spectral beam combining (SBM) techniques have also been used for coherently combining the output beams of a plurality of laser diodes. However, it has not been determined how well the emitter arrays can be locked over a 50 nm bandwidth using this SBM technique. Additionally, the SBM technique has not been extended to applications utilizing over 100,000 emitters.

Other conventional devices have been developed using optically pumped semiconductor lasers. However, these devices have a problem in scaling-up the devices. The disc lasers are typically only 6 microns thick. A disc laser of this size requires special handling techniques to build a successful disc. In addition, as the diameter of the disc is expanded to handle higher power levels, the risks of internal whisper modes, or lateral amplified spontaneous emission, increases exponentially. These parasitic whisper modes clamp the gain of the device, which makes power extraction difficult.

Talbot cavities have been used for locking-up arrays of semiconductor lasers using a surface emitter and a liquid crystal phase modulator. These devices have been successful in the locking and phase alignment of external cavities and have demonstrated near diffraction-limited performance for the grating lobes. However, the devices exhibit low efficiency and they have not been able to convert grating lobes to a single lobed far-field. Additionally, as these devices have been scaled-up in power level, they have exhibited detrimental thermal effects from misaligning of the beam fill optics. Furthermore, the grating lobes in these devices are small, and at high power there is substantial heating of the optical elements and their mounts.

Certain conventional devices have used spatial filters in an external cavity to create a coherent array. For example, a grating coupled surface emitter laser in a Fourier transform spatial filter cavity has been used. However, these designs provide no method to correct for phase errors and they have a poor fill factor. As a result, the fringe visibility (coherence) that has been reported is on the order of 40% and several of the emitters are parasitically oscillating and not adding power to the far-field lobe.

The highest power coherent laser diode array successfully locked and aligned 900 individual amplifiers in a conventional Master Oscillator Power Amplifier (MOPA) architecture. The output of the MOPA is equivalent to that of a conventional synthetic aperture. However, this system required an active phase control system to maintain the far-field lobe. This disclosure describes a passive method for locking up a large number of laser diodes thus eliminating the need for an active phase control system.

Another approach may include the use of gratings in an external cavity for diffractively coupling a large number of individual laser diodes. This approach may be useful because of the high mode selectivity of the grating. However, the applicants have discovered that in order to use the gratings in the external cavity, the excess loss of the gratings must be improved dramatically from those produced today. Additionally, the applicants have discovered that the alignment of the individual laser diodes to each of the grating lobes requires extremely precise placement of each emitter in a two dimensional array. This may be accomplished with a surface emitting design where the devices are defined photolithographically, but with a stacked array of edge emitters, the build up tolerances of the mechanical parts makes this approach very difficult.

While several conventional techniques and devices have been developed for using external cavity systems for coherently combining a large number of laser diodes, the elements of the system that are necessary to allow scaling to higher power levels have not been previously explored.

The two primary problems in any coherent scaling scheme, is how to simultaneously achieve a high fidelity temporal and spatial coherence among the individual emitters. The architectures that have been tested fall into two categories, which include active and passive. The active techniques include injection locking arrays of laser diodes and injection locking arrays of diode amplifiers combined with methods for correcting the random path differences in the system to achieve the high spatial coherence required to form a single far-field beam. The passive techniques include external cavity systems, coupled oscillator systems, and systems based on non-linear optic cells.

The present application focuses on a purely passive method using an external cavity with an adjust-and-forget method for matching the spatial coherence of the array to the spatial coherence required by the boundary conditions imposed by the optical resonator.

### SUMMARY OF THE INVENTION

In view of the foregoing and other exemplary problems, drawbacks, and disadvantages of the conventional methods and structures, an exemplary feature of the present invention is to provide a method and structure in which the coherent combination of a plurality of diodes (e.g., in an external cavity laser diode system, in accordance with an exemplary aspect of the present invention) is improved over conventional methods. The present invention provides an instant on capability for the coherent array by having a set-and-forget phase adjustment system, which is aligned during fabrication only. It is another exemplary feature of the present invention to provide a high power level coherently locked diode laser system using an external cavity laser diode system.

It is another exemplary feature of the present invention to use phase adjusters to correct phase errors in a high power level external cavity laser diode system.

To achieve the above and other features, in a first exemplary aspect of the present invention, a laser diode external cavity system includes an adjuster for intercavity phase adjustment.

In a second exemplary aspect of the present invention, a method (and system) of coherently combining a plurality of diodes in an external cavity laser diode system includes adjusting the phase of the plurality of diodes to correct phase errors, wherein the adjusting the phase includes intercavity phase adjustment.

In a third exemplary aspect of the present invention, a phase adjuster for correcting phase errors in an external cavity laser diode system includes a phase modulator integrated into at least one emitter of a plurality of emitters of said external cavity laser diode system.

With the above and other unique and unobvious exemplary aspects of the present invention, it is possible to improve the coherent combination of a plurality of diodes in an external cavity laser diode system. Additionally, the exemplary aspects of the present invention allow an external cavity laser diode system to be scaled for high power level applications.

The present invention provides for the scaling of laser diodes or arrays of laser diodes in an optical phase locked looped format. Here, a single laser diode or coherent array of laser diodes are combined with another single diode laser or coherent array of laser diodes in a 50:50 beam splitter and, depending on the phase state of the first element to the second element, the beam exhibits the sum of the power of the two sources, but with the spatial coherence preserved for both sources.

The coherent arrays, when operated in a narrow bandwidth mode, can be individually locked to reference wavelengths that are precisely spaced a fixed wavelength apart. These lasers or laser arrays can then be combined on a grating to produce a color combined beam that has the output power that is the sum of the two sources, but with the same spatial coherence as anyone of the sources used. This technique will enable scaling the output power of the laser system.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a method of combining laser diode beams using a grating inside of an external cavity according to an exemplary embodiment of the present invention;

FIG. 2 illustrates a schematic of an external cavity 200 with a spatial filter in the Fourier plane of the cavity according to another exemplary embodiment of the present invention;

FIG. 3 illustrates a physical layout 300 of the external cavity schematic depicted in FIG. 2.

FIG. 4 illustrates an industrial package 400 for an external cavity diode laser system according to an exemplary embodiment of the present invention;

FIG. 5 illustrates an exemplary external cavity laser diode system 500 using a plurality of dichroic combiners 506 according to an exemplary embodiment of the present invention;

FIG. 6 depicts a diffractive beam pattern of the X-axis of the external cavity laser diode system of the present invention;

FIG. 7 depicts a diffractive beam pattern of the Y-axis of the external cavity laser diode system of the present invention;

FIG. 8 illustrates the overlap of up to 6 laser cavities using the technique shown in FIG. 12 or 13.

FIG. 9 illustrates a layout of the external cavity 900 according to another exemplary embodiment of the present invention;

FIG. 10 illustrates the results of a Y-axis ray trace analysis 1000 for the coherent beam as it propagates through the external cavity 900;

FIG. 11 illustrates the results of a X-axis ray trace analysis 1100 for the coherent beam as it propagates through the external cavity 900;

FIG. 12 illustrates a wavelength beam combining scaling architecture 1200 according to an exemplary embodiment of the present invention;

FIG. 13 illustrates a coherent beam combining scaling architecture 1300 according to an exemplary embodiment of the present invention;

FIG. 14 illustrates phase modulators 1401 integrated into a single mode diode laser bar according to an exemplary embodiment of the present invention;

FIG. 15 illustrates active phase control electronics on a micro-channel cooler concept according to an exemplary embodiment of the present invention;

FIG. 16 illustrates an exemplary Talbot external cavity; and

FIG. 17 illustrates a high power spatial filter in accordance with an exemplary embodiment of the present invention.

### DETAILED DESCRIPTION OF EXEMPLARY EMBODIMENTS OF THE INVENTION

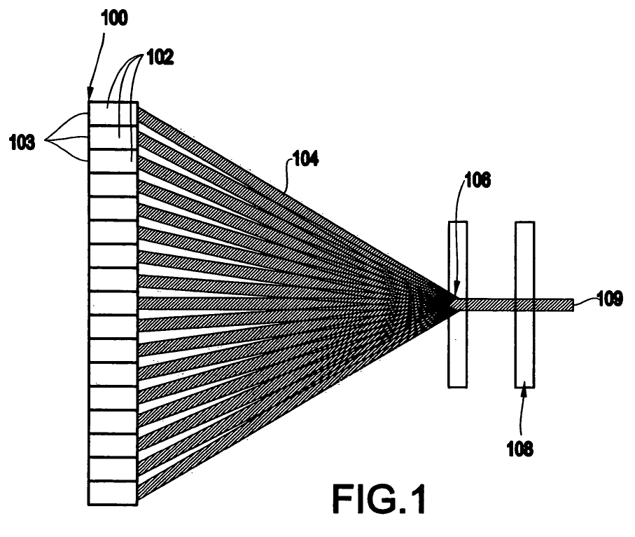

Referring now to the drawings, and more particularly to FIGS. 1-17, there are shown exemplary embodiments of the method and structures according to the present invention.

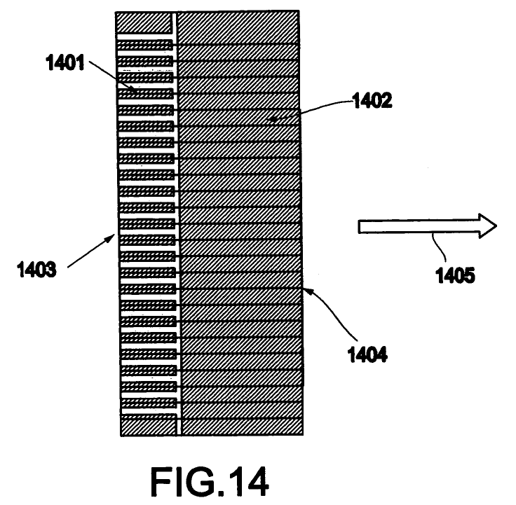

An exemplary embodiment of the present invention includes a method (and system) for building a laser diode array (e.g., a rack and stack type laser diode array according to one exemplary embodiment of the invention) using edge emitter devices with an emitter-to-emitter spacing tolerance of +/−5 microns in the X-axis and +/−50 microns in the Y-axis. The devices of the claimed invention exhibit a high electrical to optical conversion efficiency of >50% and the ability to integrate phase modulators, which are necessary for a coherent array to function (e.g., see FIG. 14).

FIG. 14 depicts exemplary phase modulators (1401) integrated into a single mode diode laser bar. The single mode diode laser bar includes a high power amplifier section 1402, an HR coating 1403 and an AR coating 1404. Arrow 1405 illustrates an output beam direction.

The emitters can be either a surface emitting or an edge emitting design. A surface emitting design is where the light is emitted perpendicular from the surface of the semiconductor and perpendicular from the surface of the heatsink. An edge emitter device is a device where the light is emitted perpendicular from a side facet of the semiconductor device and propagates parallel to the surface of the heatsink. The side facet is perpendicular to the bonding surface of the semiconductor device.

A phase modulator is integrated into at least one emitter on a laser diode bar of the laser diode array. The phase modulator may be placed anywhere in the waveguide of the individual emitter. In certain exemplary embodiments of the present invention, an adjuster may be integrated into the rear of each emitter on the laser diode bar of the laser diode array. The phase adjusters include phase modulators that correct any phase errors in the wave front of the coherent beam synthesized from the ensemble of emitters. Using the phase modulator, a flat wave front may be obtained, which is important for minimizing the side-lobes generated by the coherent array.

The phase modulators can employ any one of several well-known phase controlling techniques including thermal effect, electro-optic effect, carrier effect, and displace quantum well.

In the thermal effect technique, a forward bias can be used to modulate the phase of the individual emitters on the device. Thermal effects are due to the high dispersion of GaAs. As large current densities are passed through the junction, it heats up, which changes the index of the medium and hence the phase of the beam propagating through the medium. While thermal effect phase control has several disadvantages, i.e., the control process is slow, has multiple frequency response poles, and causes a significant amplitude modulation, it can be used in this application successfully.

In the electro-optic effect technique, both linear and higher order electro-optic effects can be used to induce significant phase changes. However, in order to produce this effect, it is necessary to apply a high electric field across the junction and consequently the quantum well. The net result is the band edge is modulated about the operating wavelength and, consequently, the output amplitude is significantly modulated. This method can be used, although it may be difficult to differentiate between amplitude modulation induced by the phase modulator and deamplitude modulation induced by the interference of emitters. It should be mentioned that Selective Area Epitaxy (SAE) techniques could be used to selectively grow a different quantum well structure, i.e., one allowing the electro-optic effect to be used without the associated amplitude modulation effects. Another technique that can be used to shift the bandgap is a selective disordering technique where the material is implanted with ions and then annealed to produce a shift in the bandgap and a corresponding reduction in the absorption.

According to the carrier effect technique, the refractive index of the phase modulator region can also be controlled by modulating the carrier density in the region. The carriers are generated by both the absorption of the optical power passing through the region and any direct current applied to the region. Generally, the carriers are modulated by applying a reverse bias across this region to sweep out the unnecessary carriers. Since a quantum well having a constant thickness throughout will result in undesirable absorption, it is necessary to use the SAE process to shift the bandgap of this region outside of the operating region and, thus, suppress the optical absorption. The selective disordering technique discussed regarding the electro-optic effect technique above can also be used.

The displace quantum well technique works by shifting the PN junction toward the N-side of the device. The source of carriers in the region will be primarily from absorption of photons from the adjacent regions or the signal passing through the region. Phase modulation is achieved by applying an electric field across the quantum well with an external bias. The photo carriers can now be depleted without causing optical absorption because the field is displaced away from the quantum well and does not cause the band edge to shift with the applied external bias.

It should be mentioned at this point, that the phase modulators require an associated phase control device. In the current embodiment, the phase modulators are assumed to be set during fabrication and alignment and held until the need to realign the cavity. However, the system may also be operated in an active mode, where the phase modulators are dithered using the techniques outlined in U.S. Pat. No. 5,694,408 which patent is incorporated herein by reference in its entirety for all purposes.

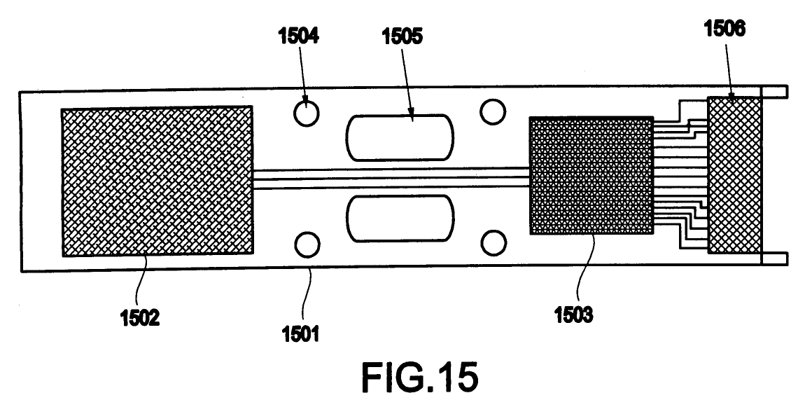

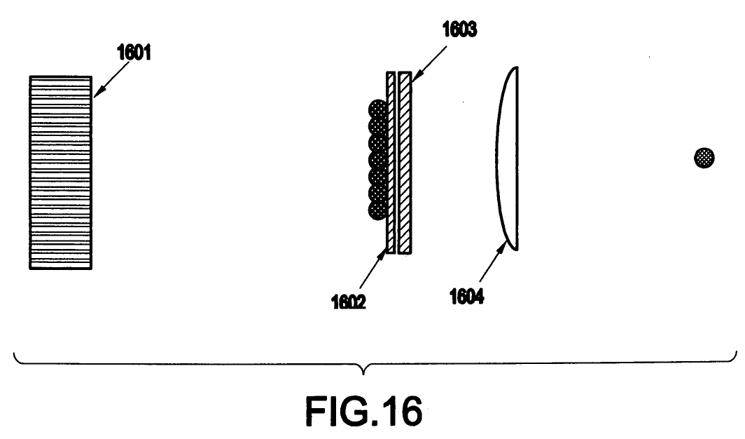

According to another exemplary feature of the invention, the external cavity diode laser system may include a control chip that enables the wave front of the array to be corrected and a resonant external cavity mode to control the operation of the coherent array. The control chip may be integrated into the laser diode array package. The control chip enables phase settings to be stored in a memory (e.g., a flash memory, etc.). This feature will enable a user to store several wave fronts that can be held or varied dynamically by digital commands. This feature is exemplary depicted in FIG. 15.

The micro-channel cooler 1501 depicted in FIG. 15 includes a PC board 1502, a control chip 1503, array mechanical passages 1504, water passages 1505 and a laser diode/phase modulator bar 1506.

The integration of a control chip is for the purpose of feeding a signal from a remote computer to the chip. The purpose of the chip is to convert a serial stream of data consisting of phase modulator address and phase modulator setting to an analog output bias delivered to the correct phase modulator. A dither based control system for testing the phase settings of each emitter and an on-axis detector for determining if the phase setting that is being changed causes the power in the far-field to either increase or decrease. The end purpose is to maximize the power delivered to the diffraction limited bucket. The phase control system can be used to continuously monitor and adjust the output beam to compensate for thermal transients or other effects which manipulate the phase settings of the individual emitters. Finally, the phase control chip can be commanded to save the optimum phase settings and reinitiated on command. Sufficient memory can be provided on the chip that several phase settings can be determined and saved and reused as a function of the drive current giving the system the ability to not only lock up passively, but also to form a beam passively.

Certain exemplary aspects of the present invention are directed to an external cavity resonator with an anamorphic optic included in the resonator. A problem with using a large array (e.g., 50 bars in a stack that is nearly 10 cm high) is that the far-field spot formed in the resonator is both small and not circular. For purposes of the present application, a bar refers to a collection of 2 or more laser diode emitters integrated on a single semiconductor substrate as shown in FIG. 14. A non-circular far-field spot requires a non-circular spatial filter. While this can be created either photolithographically, or by precision machining, it is much simpler and lower cost to create a circular spatial filter. By circularizing the beam, spherically symmetric optics can be used for the resonator and the beam that emerges is easier to manipulate, combine and transport.

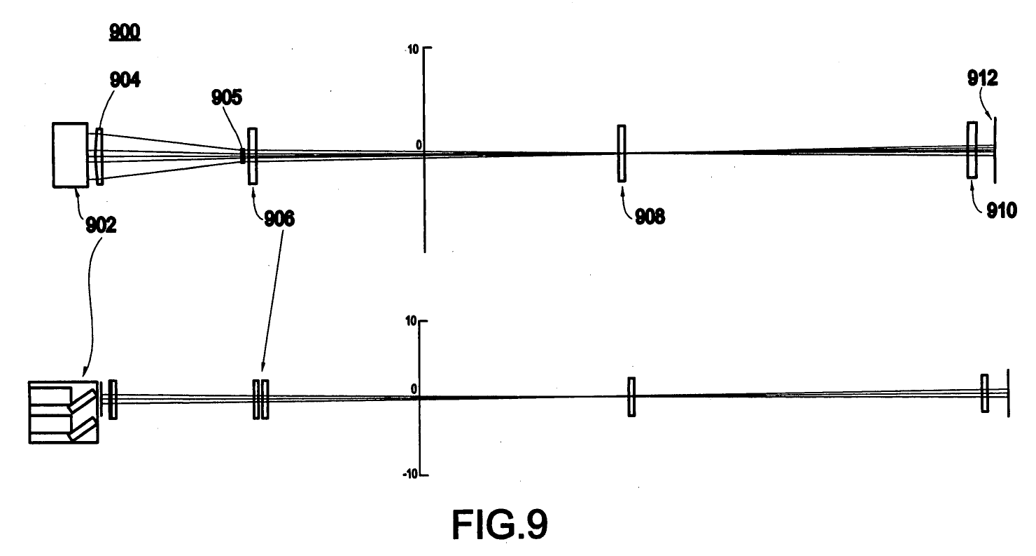

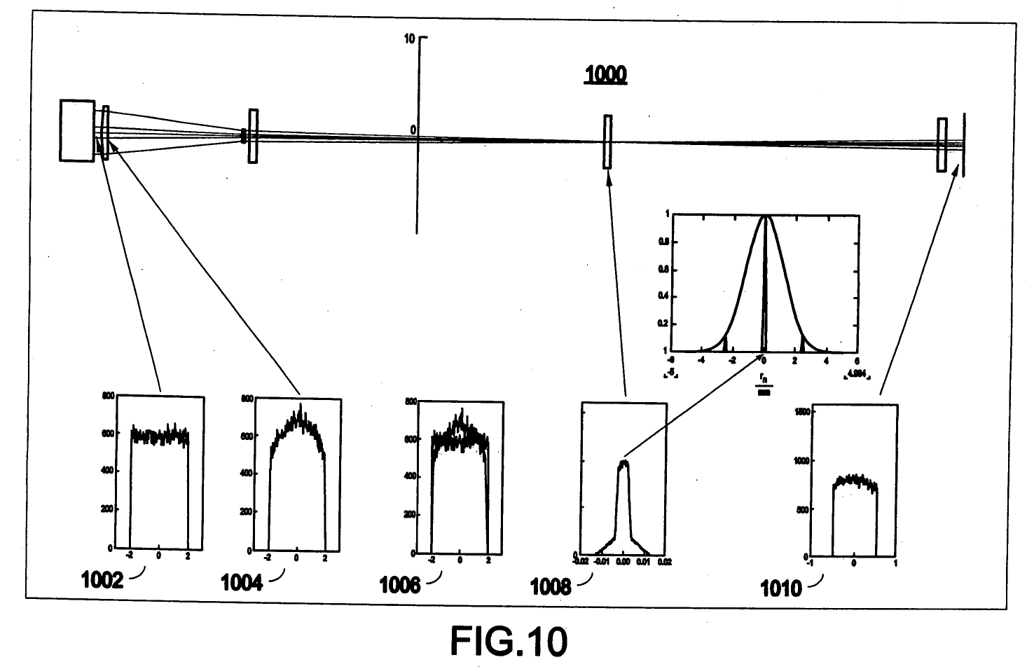

These optics are exemplarily depicted in FIG. 9. The upper figure shows a Y-axis telescope formed from the first cylindrical lens 904 and the second cylindrical lens 905. These cylindrical lenses demagnify the Y-axis of the array such that the divergence of the array in the Y-axis now matches the divergence of the array in the X-axis. The optical elements used in the rest of the cavity are all circularly symmetric, where the first focusing optic 906 focuses the beam through the spatial filter and 910 recollimates the beam.

According to one exemplary embodiment of the claimed invention, the beam combining of the laser diodes are passive. For purposes of this application, the term passive refers to a method where it is not necessary to use an external feedback loop to create the final beam. However, the method and apparatus of the claimed invention is not limited in application to passive beam combining and may be used for any known form of beam combination. Applicants have discovered that the external cavity laser diode systems of the present invention are successful for passively combining beams from a plurality of emitters.

Applicants have developed various external cavity designs. However, certain exemplary embodiments of the claimed invention are directed specifically to an external cavity laser diode system with a spatial filter. The external cavity with a spatial filter requires fewer components than other external cavity techniques. Since the array is operating in collimated space, any misalignments will result in lower power losses. Additionally, the spatial filter design allows the laser diode device to lock-up. For purposes of the present Application, the term lock-up refers to the ability of all the laser emitters to simultaneously operate at a single wavelength of light. This is advantageous because the beam cannot pass through the spatial filter unless all of the emitters are operating at the exact same wavelength and have the proper spatial coherence.

Alternatively, certain exemplary embodiments are directed specifically to a grating external cavity. The grating external cavity employs gratings to stabilize and combine the individual laser emitters at different angles. The diffraction grating is designed to split a single coherent beam into an n×m matrix of beams, where n is 1 or greater and m is greater than 1. The grating provides a high degree of modal discrimination in a cavity because it allows only the mode that forms a single lobe output beam to oscillate. Each of the beamlets propagating from the array must be in the proper angle and orientation for the grating to diffract a portion of their beam to the output coupler. The only backward traveling wave that can couple back into the individual emitters is the wavefront, which matches the diffraction orders of the grating. All other wavefronts have insufficient feedback to all of the emitters to enable oscillation.

Another exemplary embodiment of the present invention is directed to a Talbot external cavity. A Talbot external cavity includes a diffractive coupled cavity. In order for all of the emitters in a laser diode system to lock up, the Talbot diffractive coupling effect should extend over a wide number of the plurality of emitters. This effect can work for any number of emitters >1, but may be operated over hundreds of emitters to be useful in scaling the output power. The key is that the emitters are not collimated by a microlense like in other methods, but rather diffract as they exit the array at high angles. As the beams propagate, if they are coherent, they constructively interfere at certain planes along the z axis to form a rectilinear diffraction pattern of m×n spots which appears to be an exact image of the original m×n array.

However, these planes are the result of the constructive interference of many emitters and hence represent a complete mixing of the fields of the original m×n arrays and can only be formed if all of the emitters are locked to the exact same wavelength and have the proper spatial coherence. These planes of constructive interference occur when a mirror is placed at the Talbot distance: na²/λ, where n is a positive integer, a is the separation between adjacent emitters and λ is the wavelength of the emitted light (e.g., see FIG. 16). Therefore, the exemplary embodiment of the present invention using the Talbot external cavity may be used with devices where the position of the emitters is defined photo-lithographically such as is the case with vertical cavity surface emitters. However, the use of the Talbot external cavity is not limited to applications where the position of the emitters is defined in this manner.

FIG. 16 depicts an exemplary Talbot external cavity. The individual laser diode emitters 1601 have no collimating optics and the mirror 1602 is simply placed at some fractional Talbot distance to provide the degree of coupling necessary to phase lock all of the emitters. Individual phase adjusters may be used on each emitter to compensate for manufacturing tolerances since the Talbot effect produces feedback spots based on the average spacing of the laser diode emitters. Any irregularities in the spacing may result in the feedback spots not correctly aligning with the emitter and hence reduced feedback and consequently reduced coherence. This external cavity will phase lock all of the emitters, but the low fill factor of the array, i.e., no micro-optics at the array face, will result in a two dimensional grating lobe pattern at the exit aperture of the mirror.

The grating lobes are passed through a micro-lenslet array 1603 in order to fill the aperture and a transform lens 1604 to create a single far-field spot. The number of far-field lobes will be directly proportional to the fill factor of the array, where a fill factor of unity results in a single far-field lobe. A fill factor of unity is where the light leaving the lenslet array has no “dead” space between each of the lenslets and as a consequence it is fully filled with light. The Fourier transform of this near-field pattern will determine the far-field pattern, so a top hat optical wavefront will transform to a single lobe and a near-field pattern with a large amount of structure will transform to a multi-lobed far-field. The degree of locking can be characterized across the array at any time, by interfering any two emitters from the near-field emission. The degree of coherence is defined by the visibility of the fringe pattern. A fringe visibility of unity indicates 100% temporal coherence, while a fringe visibility of less than unity indicates that some of the power is not coherent and as such will not end up in the far-field single spot.

As indicated above, the present invention provides a high power diode laser stack that includes integrated phase adjusters and is precision aligned in both the X and Y axes. These phase locking techniques require the bars to be registered to each other in both axes to better than +/−5 μm.

An important feature in achieving the desired results of the present invention is the design of the diode laser stack. The design of the diode laser stack is important for the successful implementation of a Talbot type external cavity, a grating coupled external cavity, an external cavity with a spatial filter and an injection locked array. The X-axis of the bar is defined photolithographically, and, as a consequence, the placement of the emitters in the X-axis within the bar is accurate to less than 1 μm. However, when stacking bars, there are new tolerances introduced into the assembly and, each bar has to be aligned using precision parts to better than +/−5 mm in the X-axis and +/−5 mm in the Y-axis. These accuracies are necessary to reduce grating lobes in the far-field as well as to ensure complete phase locking.

According to certain exemplary embodiments of the claimed invention, single mode laser diode bars are used in the diode laser stack. Single mode laser diode bars are advantageous because their single mode spatial characteristics simplify the coherent combining of laser diode beams by eliminating the need to control the mode of the individual devices. Another key aspect of these devices is the low anti-guiding factor and the very weak lateral confinement of the mode. Because of these characteristics, these devices make excellent amplifiers.

An important feature of the present invention, which is missing in all of the conventional devices, is the ability to fix phase distortions at the stack level. The mechanical tolerances of any design result in variable path differences between the individual emitters, which result in the diffraction pattern having grating lobes that are not contained in the central lobe. This condition is defined as poor spatial coherence and is unavoidable. This design allows these variable path lengths between each of the individual emitters to be adjusted either dynamically, or once and forgotten.

Exemplary embodiments of the present invention use integrated phase modulators on the laser diode array to fix phase distortions (e.g., see FIG. 14). The integrated phase modulators enable both static system and active system operation. In the phase modulators, the p-n junction is displaced from the quantum well. The integrated phase modulators of the present invention are stable with a repeatable phase shift. It is critical in this application to be able to deterministically test for the phase shifts required by each emitter to produce the desired flat phase front at the surface of the 2-D array. Any phase fluctuations will result in a reduced spatial coherence of the array and scatter light out of the central lobe, thus reducing the efficiency of the laser system. By integrating the phase modulator in the laser diode array, it removes the alignment issues associated with other phase correction techniques.

For purposes of the present application, the method and apparatus of the present invention are exemplary applied to a 500 W coherently locked diode laser array module and a 10 kW coherently locked diode laser array module. However, the method and apparatus may be used in any high power diode laser array module. The 10 kW module includes four 3.20 kW individually coherent locked diode laser modules.

FIG. 1 depicts a method of combining laser diode beams using a grating. The device in FIG. 1 includes a diode laser array 100. The diode laser array includes a plurality of emitters 102, each of which emits a diode laser beam 104. Each of the emitters includes an integrated phase adjuster 103. The emitted diode laser beams 104 are redirected to a grating 106, which is positioned at the beam waist, by translating a collimating lens perpendicular to each emitter 102. For purposes of the present application, the term beam waist refers to an area where the beams 104 are combined. The light propagates to the output coupler, which can be either a Bragg Grating or a simple dielectric mirror. This output coupler 109, when combined with the high reflectivity back facet of the laser diodes 102, comprises the resonator for the cavity. A portion of the beam is reflected back through the grating. Only the power, has the same optical field as the original single mode source used to define the grating, is coupled back into each of the laser diode emitters. At startup, this is a small portion of light, but with each round trip the light is amplified by the laser diode array. As the light oscillates between the output coupler 109 and the laser diodes 102, it grows in strength producing a beam with both high temporal and high spatial coherence.

Again, however, when using a stack of laser diode bars, there are mechanical tolerances that produce phase distortions at the face of the laser diode array 102. These phase distortions are corrected by the integrated phase modulators 103. The process of aligning the phase modulators can be done manually or automated in a fashion similar to the phase control algorithms described in U.S. Pat. No. 6,917,729, which is incorporated herein by reference. A Bragg Grating output coupler is simply a narrow bandpass filter that is tuned to reflect only a specific wavelength of light. Consequently, the Bragg Grating, 108 is used to define the wavelength of oscillation of the external cavity.

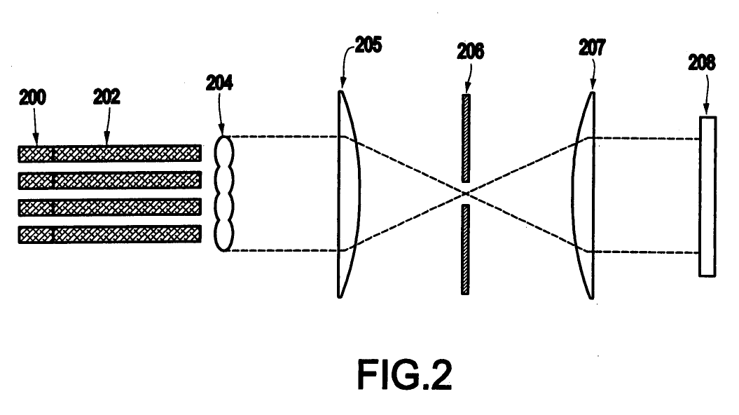

FIG. 2 depicts a schematic of an external cavity with a spatial filter 206 in the Fourier plane of the cavity. The device depicted in FIG. 2 includes an amplifier 202, which includes a stacked array of laser diodes. A phase adjuster 200 is disposed at a rear end of each laser diode in the amplifier 202. The external cavity also includes a set of micro-lenses 204 for collimating each of the individual emitters. A Fourier transform lens 205 is used to convert the angular spectrum of the incoming beam to a spot and a similar lens 207 is used to recollimate the beam after the spatial filter. A spatial filter 206 is disposed between the lenses 205 and 207 in the Fourier transform plane of the external cavity. Additionally, the external cavity device includes an output mirror 208. The output mirror 208 may include, but is not limited to, a partially reflecting mirror or a Bragg Grating reflector.

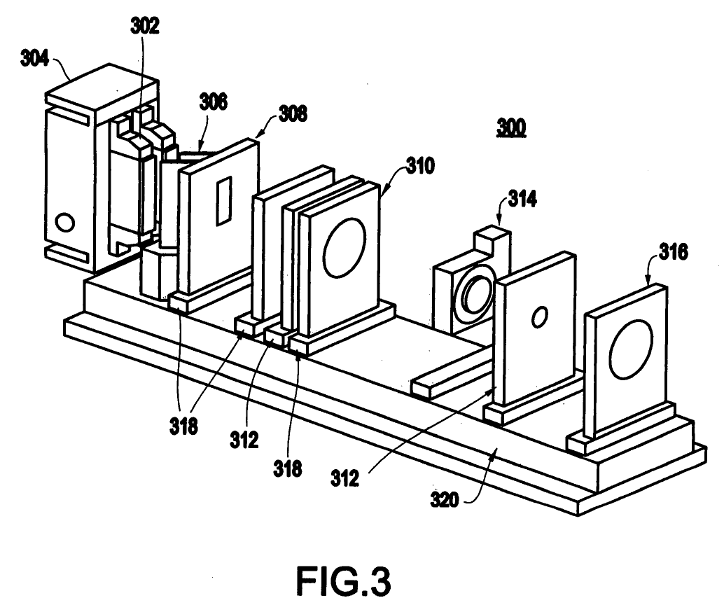

FIG. 3 depicts the physical layout of the external cavity schematic in FIG. 2. The physical layout depicted in FIG. 3 may be used for the 500 W module and the 3.20 kW module (i.e., each of the 3.20 kW modules used in the 10 kW module). The external cavity device 300 includes at least one laser diode array 302. According to certain exemplary embodiments of the claimed invention, the external cavity device 300 includes a plurality of laser diode arrays 302. The laser diode arrays 302 are enclosed in a housing 304 to protect them during assembly of the external cavity device 300.

An interdigitator 306 is disposed adjacent to the laser diode arrays 302. The beams from each laser diode bar are approximately the same height as the space between the beams from each of the laser diode bars. The interdigitator 306 is a patterned mirror which enables the beams from one array to be inserted optically into the interstitial space of the beams of another array. The effective aperture of the two combined arrays is transformed from a 50% fill factor in the vertical axis to a fully filled aperture.

The external cavity 300 includes a telescoping device 308 disposed adjacent to the interdigitator. According to certain exemplary embodiments of the present invention, the telescoping device 308 includes a 4:1 Y-axis telescope. The telescope changes the effective beam divergence of the coherent aperture by a factor of 4 and produces a beam divergence the same as the X-axis. Another method for changing the beam divergence of the Y-axis uses an anamorphic prism pair.

An output mirror 316 is disposed at an end of the external cavity 300 opposite from the laser diode arrays 302. The output mirror 316 is the primary feedback source for the external cavity and completes the resonant cavity with the rear facet of each of the laser diode arrays 302.

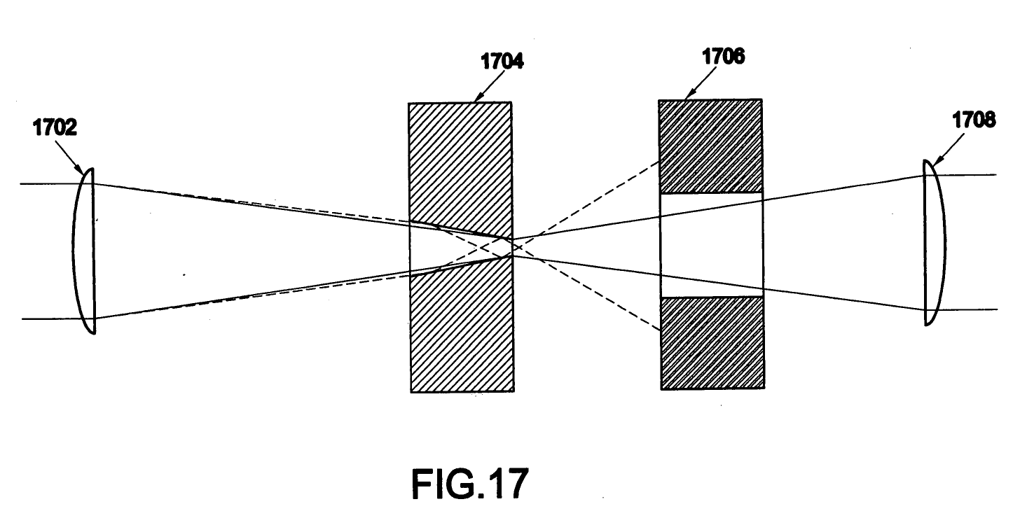

A spatial filter assembly 314 is disposed between the laser diode arrays 302 and the output lens 316. A focal lens 310 is disposed between the telescoping device 308 and the spatial filter assembly 314. The focal lens 310 may include, for example, a 48 cm focal lens. A first beam dump 312 is disposed between the telescoping device 308 and the focal lens 310 for focusing the beam. A second beam dump 312 is disposed between the spatial filter assembly 314 and the output lens 316. The spatial filter is a cone shaped device that tapers from a large aperture to the desired aperture. The taper is polished and coated with gold to make it sufficiently reflective to act as a non-imaging concentrator. Any power that is outside of the desired aperture intercepts the surface of the taper and its angle is increased outside of the angular acceptance of the optical system (e.g., see FIG. 17). The optical power that is scattered outside of the angular acceptance angle is then intercepted by a beam dump 312 with a larger hole that allows only the power within the acceptance angle to be passed. This design enables the spatial filter to operate at very high power levels because the rejected power is absorbed over a much larger surface than the small aperture of the spatial filter. The surface of the beam dump 312 has a highly absorptive coating.

The spatial filter 314, rather than absorb the optical power at the spatial filter 314, reflects, or transmits the unwanted energy in such a way as to increase the angular divergence of the unwanted energy. The beam dump 312 has a sufficiently large hole in it to pass the central beam while truncating the energy being deflected into higher angles. This spatial filter 314 has shown the ability to strip hundreds of Watts of power from the beam despite very high fluence levels at the spatial filter.

Each element of the external cavity 300 described above is arranged on a base plate 320 by one of a plurality of lens mounts 318. The base plate 320 and all the lens mounts 318 are made from, for example, stainless steel and are water cooled. The laser diode arrays are manufactured out of copper and require the use of deionized water for cooling. The only materials compatible with the copper coolers are stainless steel and plastics. The baseplate and optical mounts must be isothermal to prevent any drifts in the position of the laser beam at the center of the spatial filter. All of the mechanical surfaces on the external cavity are coated with a black finish to insure that any scattered radiation is absorbed in the water-cooling system.

The external cavity 300 depicted in FIG. 3 provides a coherent array module locked to a single wavelength. The output beam of the external cavity laser diode system 300 is a TEM₀₀ mode.

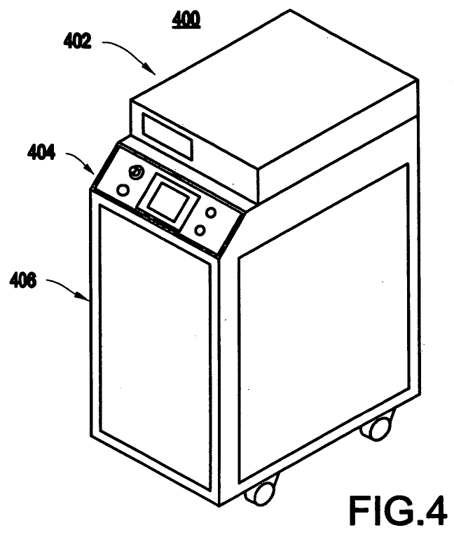

FIG. 4 depicts an industrial package 400 for the 500 W external cavity diode laser system (a similar package is used for the 10 kW system). The package 400 includes the laser system 402, a controller 404 for controlling the system, and a power supply cabinet 406. The laser system 402 is disposed on top of the controller 404 and the power supply cabinet 406. The emitted coherent laser beam may exit from a side of the package 400 or vertically from a top of the package 400.

Additionally, the package may include a fiber coupler. The fiber coupler is disposed at a point where the laser beam exits the laser system 402. The fiber coupler couples the output into a small optical fiber and the power is routed to the work piece via the optical fiber.

As indicated above, the external cavity laser diode system 300 depicted in FIG. 3 is used for the 500 W module and the 3.20 kW modules. The difference between the 500 W module and the 3.20 kW module is that the 3.20 kW module includes a larger number of bars in the stacked laser diode array 302 than the 500 W module. In accordance with certain exemplary embodiments of the claimed invention, the 500 W module includes two 10 bar stacks of laser diodes, while the 3.20 kW modules includes two 50 bar stacks of laser diode bars.

In the 10 kW module, the output of each of the 3.20 kW modules is combined to provide a single output for the 10 kW module. The output beams are combined using a wavelength combiner. The external cavity laser diode system 300 of the present invention may use any appropriate wavelength combining technique including, but not limited to, dichroic combining, grating wavelength beam combining using Bragg gratings, and high power water cooled grating combining. The external cavity system 300 is combined with the wavelength combiner.

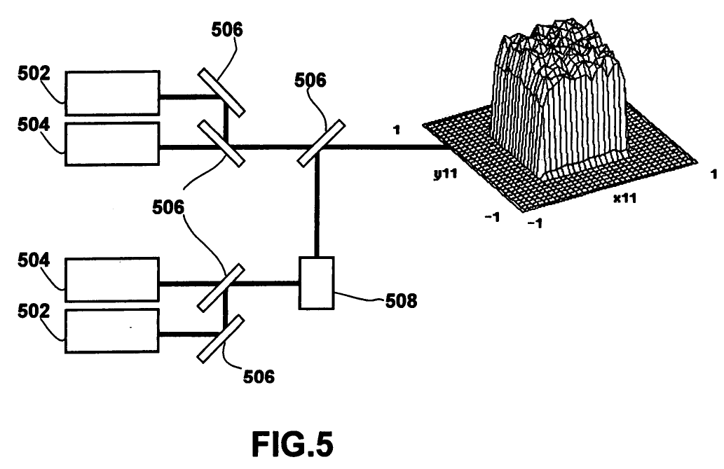

FIG. 5 depicts an example of the 10 kW system 500 using a plurality of dichroic combiners 506. As indicated above, the 10 kW system 500 includes four 3.20 kW modules. The four 3.20 kW modules may include a module centered at any wavelength from 800 nm to 1.5 μm 502 and a module center at 40 nm 504 from the first center wavelength. These modules may be pulled +/−10 nm by an external optical element if necessary. The output beams from each of the 3.20 kW modules 502, 504 are combined using a plurality of dichroic combiners and a high power polarizer 508, and will include a polarization rotation optic for rotating the polarization of the one set of arrays perpendicular to the other set of arrays.

A high power polarizing optic may include a single dielectric coating on a plate, or could be an air spaced element. The high power levels used in this system prevent the use of a lower power polarization element which may be manufactured using optical contacting or glue. Other color combining techniques could include a Bragg Grating, a high power grating, or a prism. Any technology which provides sufficient wavelength dispersion is suitable for color combining multiple modules.

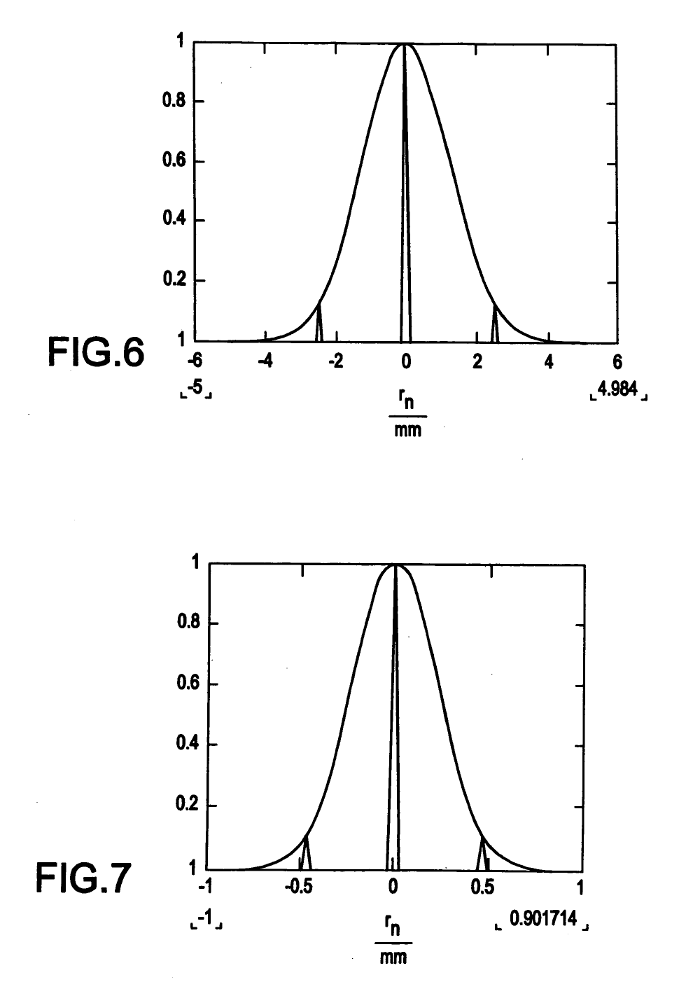

The final beam characteristics of the system 300 are determined by the spatial filter 314 in the 500 W module and the 10 kW module. The diffractive beam pattern of the X-axis and the Y-axis is shown in FIGS. 6 and 7, respectively. Specifically, FIG. 6 depicts the X-axis spot at the focal plane of the 48 cm lens. The grating lobes for this cavity are sufficiently far off-axis that they can easily be suppressed by the spatial filter. Specifically, the first major grating lobes are over 2 mm off axis and are easily rejected by the spatial filter.

When the individual phases of each emitter are set to provide a flat wave front (modulo 2π) the laser cavity oscillates in the same manner as a standard laser. The grating lobes are truncated and the beam, which emerges from the cavity will be a circularly symmetric TEM₀₀ mode. Less than 30% of the power is lost by truncating the grating lobes.

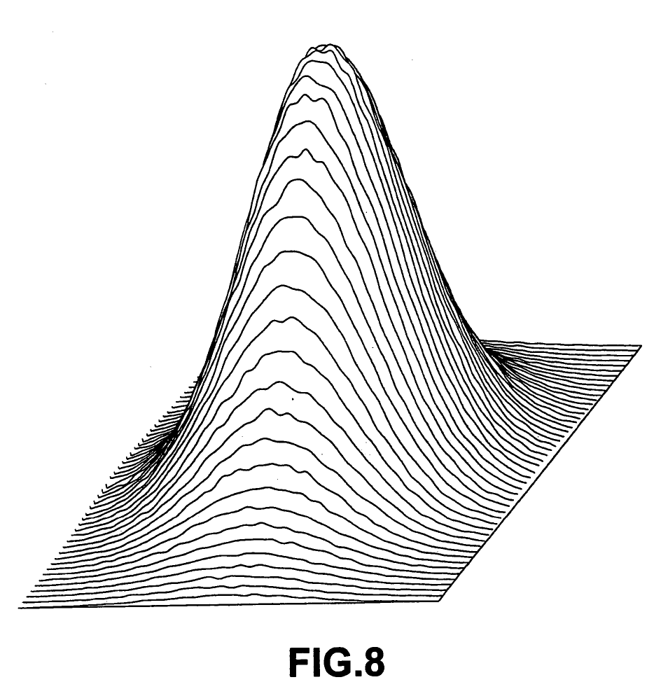

FIG. 7 specifically depicts the Y-axis grating lobes without the 4:1 mean reduction telescope. When the telescope is inserted, the beam is sufficiently the same as the X-axis. FIG. 8 shows the overlap of the 10 kW beam pattern in a 12 cm exit aperture. FIG. 6 illustrates the three primary lobes generated by the array in the X-axis. The relative intensity of each of the lobes is proportional to their position within the envelope defined by the far-field profile of the individual emitters. Their position within the envelope is defined by the spacing between each of the individual emitters and the width of each beam is defined by the fill factor of the array. The higher the fill factor, the narrower the beams. FIG. 7 depicts the same beam characteristics for the Y-axis and FIG. 8 is the single far-field Gaussian beam expected from the laser system after the truncation of the sidelobes in the x and y axis.

Two important features of the external cavity include the demonstration of a high power coherent laser diode array and the demonstration of the wavelength multiplexing of the high power coherent laser modules. The gain element of the external cavity is important for providing each of the above important features.

Referring again to FIG. 2, the phase adjusters 200 insure that the round trip phase is resonant in the cavity and that the micro lenses provide near-field aperture filling and result in the far-field patterns shown in FIGS. 6 and 7. FIGS. 11, 12 and 17 show that the size of the through aperture of the spatial filter is chosen to just pass the central lobe of the coherent beam effectively truncating the sidelobes in the X and Y axes. Since the only mode which can oscillate is the one that fits through the spatial filter, then the only oscillation allowed is that of the coherent phase aligned mode. However, mechanical tolerances in the system cause random phase errors throughout the array, as a result, the power transmitted through the spatial filter will be inefficient until the phase errors are corrected.

FIG. 9 depicts a layout of the external cavity according to the present invention. The exemplary embodiment of the external cavity 900 depicted in FIG. 9 is arranged for the 500 W module. The 500 W system includes laser diode arrays 902. Each of the laser diode arrays 902 includes a stack of laser diode bars with 50 emitters on each bar. Each laser diode array 902 includes up to 20 bars in a stack, which will form a near-field aperture that is approximately 4 cm tall in the Y-axis or a factor of four times the X-axis.

An anamorphic optic is used in the Y-axis to equalize both the near-field and the angular divergence of the Y-axis with the near-field and angular divergence of the X-axis. An anamorphic optic is an optical element with more power in one axis than the other. In this case, the anamorphic optic is made up of two cylindrical lenses which effectively compress the Y-axis to the exact same size and angular divergence as the X-axis.

The beams for the laser diode arrays 902 are co-aligned by the interdigitator 907 and reflecting mirrors 903. Once the beams are co-aligned, they are launched into the anamorphic optic (e.g., the first and second cylindrical lenses 904 and 905) to circularize the beams. The circularized beam is then launched into the spatial filter assembly by the first focusing optic 906. According to the exemplary embodiment of the present invention depicted in FIG. 9, the first focusing optic may be a 48 cm focal length lens. The optic brings both axes to focus at a common spot where a spatial filter 908 can be used to attenuate any optical modes that do not fit within the physical diameter of the spatial filter. As the beam exits the spatial filter 908 the power that is reflected outside of the beam is absorbed by a beam dump. As the beam continues to propagate, the second optic, e.g., a lens of 48 cm focal length, recollimates the beam before reaching a mirror. The mirror reflects a portion of the incident radiation and passes the rest. The reflected portion provides the feedback necessary in the laser cavity to create a laser oscillation when the mode that is trying to oscillate has sufficient gain to overcome any cavity losses.

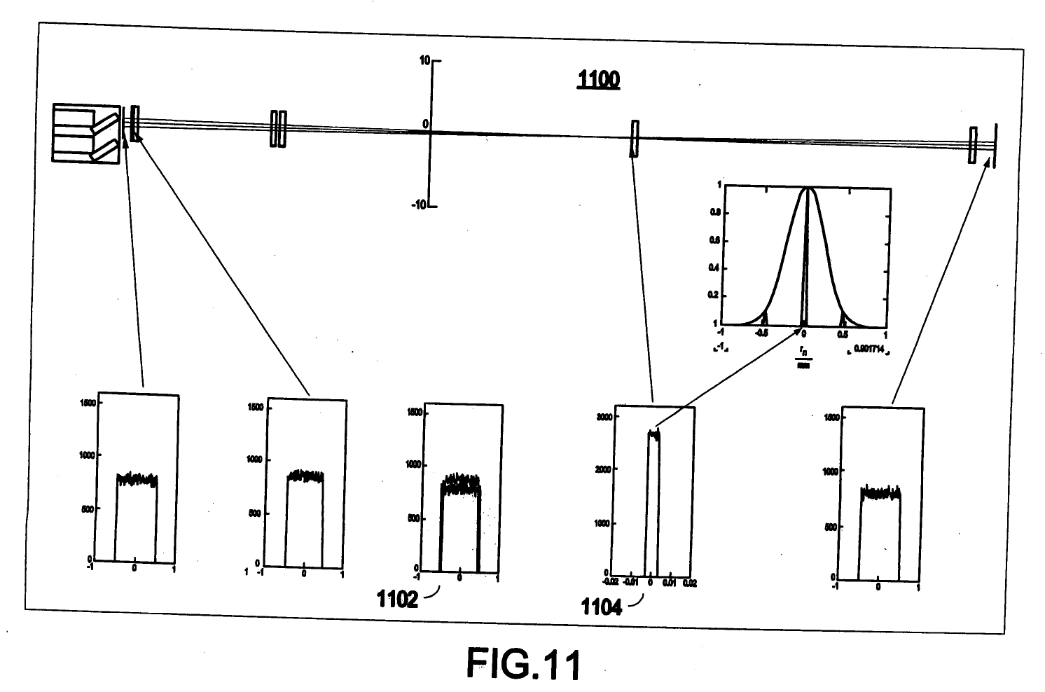

FIG. 10 depicts the results of a Y-axis ray trace analysis 1000 for the coherent beam as it propagates through the external cavity 900. At the beam launch 1002, the beam appears as a uniform illumination with a flat phase front. The next graph 1004 shows what the beam looks like after a round trip through the laser cavity. For purposes of the present application, the term round trip refers to a beam that travels through the external cavity and is reflected back to the laser diode array. When the launch 1002 and round trip 1004 graphs are overlapped, the ray trace patterns overlap indicating that the mode is stable (e.g., 1006) which is the classical definition of a laser resonator. That is, the mode of a laser cavity is an optical field, which after one round trip replicates itself, which is a requirement to establish a laser beam. The spot formed in the Y-axis at the spatial filter shows spherical aberrations that originated in the Y-axis telescope (e.g., 1008). The final graph (e.g., 1010) is a ray trace result showing that the uniform illumination used in the analysis is replicated at the exit of the laser cavity. Any other shape would suggest that the mode was not stable or that the losses were too high for the laser to oscillate in a single TEMₒₒ mode.

The ray-trace analysis of the X-axis 1100 shown in FIG. 111 demonstrates the same round trip stability (e.g., 1102) as in the Y-axis. Since the X-axis does not undergo a 4:1 contraction like the Y-axis, the spot, at focus, does not show signs of the spherical aberrations on the Y-axis (e.g., 1104).

This ray trace analysis was performed assuming the output beam from the array is coherent across the entire aperture. When the same analysis is repeated for the individual beamlets, only 35% of the energy from the array returns to the array in a round trip compared to 100% in the coherent case (not including output coupling losses). When a single spatial filter is placed in the cavity, less than 1% of the rays for the individual beamlets complete a round trip. This represents a 20 dB mode discrimination between the coherent mode and the incoherent mode.

The output beam from this cavity resembles the near-field of the resized array in the Y-axis and the normal array in the X-axis, TEM₀₀ spot. Focusing the near-field from the arrays to the far-field will create a circular spot with diffraction lobes in the two axes.

The grating lobes are spaced at the spatial frequency of the near field, which is the wavelength of light divided by the spacing between the emitters. The modulation of the grating lobes is a result of the Gaussian beam envelope as determined by the size of the individual beamlet lenses. In both cases, the fill factor is optimized to suppress the grating lobes as far as possible.

For example, in the X-axis, the emitters are spaced at 200 microns, which corresponds to an angular separation between the grating lobes of 5 mradians. Now, if the lateral mode is truncated at the 1/e² point in power in the near-field then the lens is optimally filled and the diffracting aperture is 200 microns. This corresponds to a Gaussian beam that has a divergence of approximately 10 mradians. Since the grating lobe is at 5 mradians off axis, the amplitude is greatly suppressed by the Gaussian modulation envelope.

Similarly, in the Y-axis, the Gaussian envelope has a divergence of 1.32 mrad and the first grating lobe is 0.99 mradians off axis. The net result is the grating lobes carry little power in this design and are attenuated at the spatial filter without degrading the performance of the system. Since the spatial filter adequately controls the beam, the spot is circularized as it exits the laser cavity.

The spatial filter of the present invention suppresses the Gaussian envelope while enabling the central far-field to develop. This highly filled array achieves the maximum possible power in the central lobe when using a synthetic aperture with truncated Gaussian beams.

Additionally, certain exemplary embodiments of the claimed invention include methods (and systems) of scaling the coherent output beam from the external cavity to higher power levels. The present invention provides two exemplary scaling architectures.

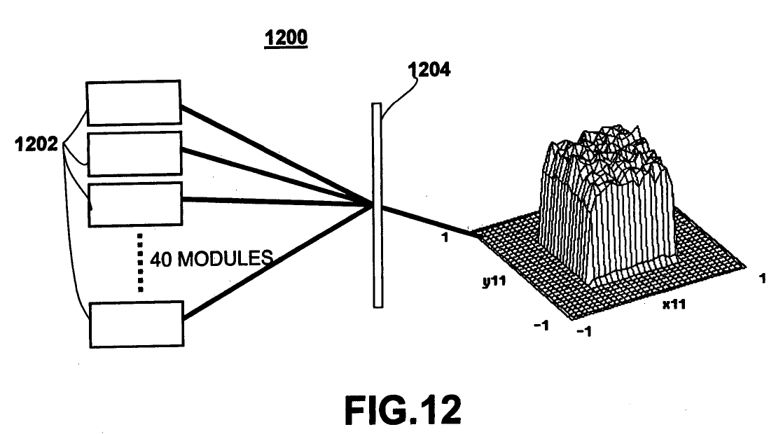

A first exemplary architecture 1200 includes wavelength division multiplexing of the base coherent modules, which is depicted in FIG. 12.

This technique will enable a completely passive system. Scaling the output beam from the coherent modules results in a final beam having power of up to 100 kW. The scaling is accomplished by combining the output beams of 40 coherent 3.20 kW modules 1202 with a high power combining grating 1204.

The angular dispersion of the grating combined with the physical limitations of the finite size of the modules defines the angular spacing for each of the modules. For example, the final beam combining must be performed within a 5 degree angle, thus each module is spaced approximately 2.1 mrad apart. This results in long path lengths for the system, or additional optical elements for shearing the modules 1202 together within the requisite angle space. For example, in order to obtain a 0.5 cm separation between beams, it will take a path length of 2.35 meters.

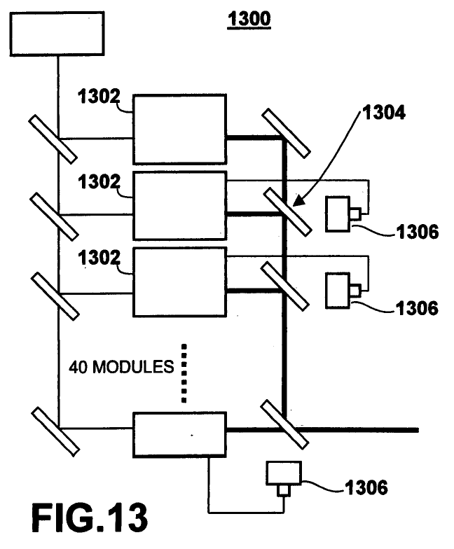

Alternatively, the second exemplary scaling architecture, depicted in FIG. 13, provides a more compact structure. The scaling architecture 1300 depicted in FIG. 13 is based on an optical phased locked loop architecture. The architecture 1300 proposed here operates, in principle, similarly to a homodyne detection scheme found in a coherent optical communication systems. The output power of the homodyne detector 1300 is maximized when the beams from each of the 40 coherent modules 1302 are in phase. Each of the modules is kept in phase by minimizing the amount of light passing straight through the beam-splitter 1304. This approach requires the use of localized control loops 1306 to adjust the piston phase of each injection-locked oscillator. In accordance with certain exemplary embodiments of the present invention, the control loops include beam dumps with photodetectors. The photodiode detects the power transmitted through the 50:50 beam splitter. The signal from the photodiode is used to drive the phase bias of the phase modulators on the array in the local loop until the photodiode signal is minimized. Once the signal is minimized, the gain in the loop is optimized to minimize the transmitted power. The net result is all of the power is transmitted out the other side of the 50:50 beam splitter.

FIG. 17 shows the details of the unique spatial filter. Previous implementations of the spatial filter are based on absorbing the unwanted power at the surface of the spatial filter or reflecting it. This method uses a unique non-imaging concentrator approach to recondition the angular divergence of the unwanted light to an angle that is much greater than the acceptance angle of the resonator. The beam is first focused by the input lens 1702 to a spot and the exit of the spatial filter 1704 is placed at the Fourier transform plane for the incoming beam. The unwanted power is rejected from the beam because it leaves the spatial filter at a much greater angle than it entered as a result of reflecting off of the tapered surface of the spatial filter. This unwanted power is allowed to propagate to a beam dump 1706, which is coated by an absorptive coating to insure the power is absorbed into the beam dump. The beam, which is passed by the beam dump, is now recollimated by the second lens 1708.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. An external cavity laser diode system, comprising:
an adjuster for intercavity phase adjustment of the external cavity laser diode system.

2. The external cavity laser diode system according to claim 1, further comprising:
a laser diode array comprising a plurality of laser diode emitters.

3. The external cavity laser diode system according to claim 2, further comprising:
a filter for combining laser diode output beams emitted from said laser diode emitters into a single coherent output beam.

4. The external cavity laser diode system according to claim 3, wherein said filter comprises at least one of a grating, an etalon filter, a mirror and a spatial filter.

5. The external cavity laser diode system according to claim 3, wherein said filter comprises a grating.

6. The external cavity laser diode system according to claim 3, wherein said filter comprises a spatial filter.

7. The external cavity laser diode system according to claim 1, wherein the external cavity laser diode system comprises one of a Fourier transform external cavity, a spatial filtered external cavity and a Talbot cavity external cavity.

8. The external cavity laser diode system according to claim 1, further comprising:
an anamorphic optic for circularizing an output beam of the external cavity laser diode system.

9. The external cavity laser diode system according to claim 8, wherein said anamorphic optic is disposed externally to the external cavity laser diode system.

10. The external cavity laser diode system according to claim 8, wherein said anamorphic optic is disposed internally to the external cavity laser diode system.

11. The external cavity laser diode system according to claim 5, further comprising:
at least one of an etalon filter and a Bragg grating for controlling a central wavelength of said laser diode array.

12. The external cavity laser diode system according to claim 2, wherein said external cavity laser diode system comprises a plurality of external cavity modules, and
wherein said external cavity modules comprise a filter for combining laser diode output beams emitted from said laser diode emitters into a single coherent output beam.

13. The external cavity laser diode system according to claim 12, further comprising:
a wavelength combiner for coherently combining said single coherent output beam of said external cavity modules.

14. The external cavity laser diode system according to claim 13, wherein said wavelength combiner comprises an external grating.

15. The external cavity laser diode system according to claim 13, wherein said wavelength combiner comprises an optical phase locked loop.

16. The external cavity laser diode system according to claim 2, wherein said laser diode array comprises a stacked bar diode array comprise a plurality of stacked bar diodes.

17. The external cavity laser diode system according to claim 16, wherein said phase adjuster comprises a phase modulator disposed in line with the emitter in said bar diodes in said stacked bar diode array.

18. A method of coherently combining output beams from a plurality of diodes in an external cavity laser diode system, comprising:
adjusting the phase of said plurality of diodes to correct phase errors,
wherein said adjusting comprises intercavity phase adjustment.

19. A phase adjuster for correcting phase errors in an external cavity laser diode system, comprising:
a phase modulator integrated into at least one diode of a plurality of diodes in the external cavity laser diode system.
